(19) United States
(12) Patent Application Publication
(10) Pub. No.: US 2013/0029211 A1
(43) Pub. Date: Jan. 31, 2013

(54) Rechargeable Battery

(71) Applicants: Jae-Il Seong, Yongin-si (KR); Hideaki Yoshio, Yongin-si (KR); Kyung-Keun Lee, Yongin-si (KR); Jin-Wook Kim, Yongin-si (KR); Ji-Wan Jeong, Yongin-si (KR)

(72) Inventors: Jae-Il Seong, Yongin-si (KR); Hideaki Yoshio, Yongin-si (KR); Kyung-Keun Lee, Yongin-si (KR); Jin-Wook Kim, Yongin-si (KR); Ji-Wan Jeong, Yongin-si (KR)

(73) Assignee: SAMSUNG SDI CO., LTD., Yongin-si (KR)

(21) Appl. No.: 13/303,893

(22) Filed: Nov. 23, 2011

Related U.S. Application Data
(60) Provisional application No. 61/512,732, filed on Jul. 28, 2011.

(51) Int. Cl. H01M 2/06

(52) U.S. Cl. 429/179

(57) ABSTRACT

A rechargeable battery that prevents an internal short circuit of a cell by inducing bending of a cap plate and a case at a predetermined location and in a predetermined direction under a longitudinal compression condition. The rechargeable battery includes a case having a front sidewall opposite a back sidewall, a bottom wall opposite an opening and joint portions connecting the bottom wall to each of the front and back sidewalls, an electrode assembly arranged within the case, a cap plate arranged within the opening of the case to seal within the electrode assembly, the cap plate including at least one bend inducing groove, a curvature of an inner curved surface of portions of the joint portions arranged within the center portion being greater than a curvature of an inner curved surface of portions of the joint portions arranged within the side portions.

### CLAIM OF PRIORITY

This application makes reference to, incorporates the same herein, and claims all benefits accruing under 35 U.S.C. §119 from an application earlier filed in the U.S. Patent and Trademark Office on 28 Jul. 2011 and there duly assigned Ser. No. 61/512,732.

### BACKGROUND OF THE INVENTION

1. Field of the Invention

The described technology relates generally to a rechargeable battery for inducing bending of a cap plate under a longitudinal compression condition.

2. Description of the Related Art

A rechargeable battery can repeatedly perform charge and discharge, unlike a primary battery, and includes, for example, a nickel-hydrogen battery, a lithium battery, and a lithium ion battery, and is manufactured in a pack form to be widely used in a portable electronic device such as a mobile phone, a laptop computer, and a camcorder.

The rechargeable battery includes an electrode assembly that is spiral-wound in a jelly roll form by stacking a positive electrode and a negative electrode with a separator interposed therebetween, a case that houses the electrode assembly together with an electrolyte solution, and a cap plate that seals an upper opening of the case, and an electrode terminal installed in the cap plate and electrically connected to the electrode assembly.

For example, the case can have a cylinder shape or a square shape and be made out of aluminum or an aluminum alloy. When the case is compressed and changed by pressure applied in a vertical direction with respect to a top-down direction of the squared case, that is, in the longitudinal compression condition, the cap plate may not be bent or it can be bent at an unspecified point.

Accordingly, the case can be bent in a random direction or the positive electrode and the negative electrode can be short circuited inside the electrode assembly because of the problem of bending of the case. The internal short circuit of the rechargeable battery can cause burning or explosion.

The above information disclosed in this Background section is only for enhancement of understanding of the background of the described technology and therefore it may contain information that does not form the prior art as per 35 U.S.C. §102.

### SUMMARY OF THE INVENTION

The described technology has been made in an effort to provide a rechargeable battery for preventing an internal short circuit of a cell by inducing bending of a cap plate in a predetermined direction under a longitudinal compression condition.

The present invention has been made in another effort to provide a rechargeable battery for preventing an internal short circuit of a cell by inducing bending or folding of a case in a predetermined direction under a longitudinal compression condition.

The present invention has been made in another effort to provide a rechargeable battery for preventing burning and explosion under the longitudinal compression condition.

According to one aspect of the present invention, there is provided a rechargeable battery including a case having a front sidewall opposite a back sidewall, a bottom wall opposite an opening and joint portions connecting the bottom wall to each of the front and back sidewalls, the front and back sidewalls and the corresponding joint portions of the case each having a center portion and side portions on either side of the center portion and extending from the opening to the bottom wall, an electrode assembly arranged within the case, a cap plate arranged within the opening of the case to seal within the electrode assembly, the cap plate including at least one bend inducing groove and an electrode terminal extending through the cap plate and being electrically connected to the electrode assembly, wherein a thickness of the front and back sidewalls of the case may be less than a thickness of the bottom wall of the case, wherein a curvature of an inner curved surface of portions of the joint portions arranged within the center portion may be greater than a curvature of an inner curved surface of portions of the joint portions arranged within the side portions.

A thickness of portions of the joint portions of the case arranged within the center portion may be smaller than a thickness of portions of the joint portions of the case arranged within the side portions. A thickness of the front and back sidewalls of the case within the center portion may be equal to a thickness of the front and back sidewalls of the case within the side portions.

The cap plate may include a long length direction and a relatively shorter width direction that extends from the back sidewall to the front sidewall of the case, the cap plate may be perforated by a terminal hole at a center of the cap plate through which the electrode terminal extends, the cap plate may also be perforated by an electrolyte injection hole. The at least one bend inducing groove may be arranged between the electrolyte injection hole and the terminal hole and may extend only a portion of a width of the cap plate in the width direction and a length of the bend inducing groove may be greater than a diameter of the terminal hole. The at least one bend inducing groove may include two bend inducing grooves, one on either side of the terminal hole and extending an entire width of the cap plate in the width direction. The at least one bend inducing groove may include two bend inducing grooves, one on either side of the terminal hole and extending only a portion of a width of the cap plate in the width direction. The at least one bend inducing groove may be arranged between the electrolyte injection hole and the terminal hole and extending in a direction that forms an angle with the width direction of the cap plate. The at least one bend inducing groove may include two bend inducing grooves, one on either side of the terminal hole and extending in a direction that forms an angle with the width direction of the cap plate. The at least one bend inducing groove may be arranged between the electrolyte injection hole and the terminal hole and have a “V” shape having an apex that points toward the terminal hole. The at least one bend inducing groove may include two bend inducing grooves, one on either side of the terminal hole, each bend inducing groove may have a “V” shape and having an apex that point towards the terminal hole. The at least one bend inducing groove may be arranged between the electrolyte injection hole and the terminal hole and have a “V” shape having an apex that points away from the terminal hole. The at least one bend inducing groove may include two bend inducing grooves, one on either side of the terminal hole, each bend inducing groove may have a “V” shape and having an apex that points away from the terminal hole.

The rechargeable battery may also include an insulating gasket arranged within the terminal hole of the cap plate to insulate the electrode terminal from the cap plate. The rechargeable battery may also include a terminal plate electrically connected to the electrode terminal and being arranged between the electrode assembly and the cap plate, an insulating plate arranged between the cap plate and the terminal plate to insulate the terminal plate from the cap plate and an insulating case arranged between the terminal plate and the electrode assembly to electrically insulate the terminal plate from the electrode assembly.

According to another aspect of the present invention, there is provided a rechargeable battery that includes a case having a front sidewall opposite a back sidewall, a bottom wall opposite an opening and joint portions connecting the bottom wall to each of the front and back sidewalls, the front and back sidewalls and the corresponding joint portions of the case each having a center portion and side portions on either side of the center portion and extending from the opening to the bottom wall, an electrode assembly arranged within the case, a cap plate arranged within the opening of the case to seal within the electrode assembly, the cap plate including at least one bend inducing groove and an electrode terminal extending through the cap plate and being electrically connected to the electrode assembly, wherein a thickness of the front and back sidewalls of the case may be less than a thickness of the bottom wall of the case, wherein a thickness of portions of the joint portions of the case arranged within the center portion may be smaller than a thickness of portions of the joint portions of the case arranged within the side portions.

According to yet another aspect of the present invention, there is provided a rechargeable battery that includes a case having a front sidewall opposite a back sidewall, a bottom wall opposite an opening and joint portions connecting the bottom wall to each of the front and back sidewalls, the front and back sidewalls and the corresponding joint portions of the case each having a center line extending from the opening to the bottom wall, an electrode assembly arranged within the case, a cap plate arranged within the opening of the case to seal within the electrode assembly, the cap plate including at least one bend inducing groove and an electrode terminal extending through the cap plate and being electrically connected to the electrode assembly, wherein a thickness of the front and back sidewalls of the case may be less than a thickness of the bottom wall of the case, wherein a curvature of an inner curved surface of the joint portions may be greatest at the center line and decreases gradually with distance away from the center line. A thickness of the joint portions of the case may be smallest at a center line and increase gradually with distance away from the center line.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 shows an exploded perspective view of a rechargeable battery according to a first exemplary embodiment;

FIG. 2 shows a cross-sectional view with respect to a line II-II when a rechargeable battery of FIG. 1 is combined;

FIG. 3A shows a bottom plan view of a cap plate applicable to a rechargeable battery of FIG. 1;

FIG. 3B shows a cross-sectional view with respect to a line IIIb-IIIb of FIG. 3A;

FIG. 3C shows a perspective view of a rechargeable battery according to a first exemplary embodiment under a longitudinal compression condition;

FIG. 4A shows a bottom plan view of a cap plate applicable to a rechargeable battery according to a second exemplary embodiment;

FIG. 4B shows a perspective view of a rechargeable battery according to a second exemplary embodiment under a longitudinal compression condition;

FIG. 5 to FIG. 12 show bottom plan views of a cap plate applicable to a rechargeable battery according to third to the tenth exemplary embodiments;

FIG. 13 shows a front view of a rechargeable battery according to an eleventh exemplary embodiment;

FIG. 14 shows a cross-sectional view with respect to a line XIV-XIV of FIG. 13;

FIG. 15 shows a top sectional view of a case near the bottom wall of the case with respect to a line XV-XV of FIG. 13 showing a section of joint portions of the case of FIG. 13;

FIG. 16 shows a cross-sectional view of and about a joint portion of the case in first area A1 with respect to a line XVI-XVI of FIG. 15;

FIG. 17 shows a cross-sectional view of and about a joint portion of the case in second area A2 with respect to a line XVII-XVII of FIG. 15; and

FIG. 18 shows a top sectional view of the case near the bottom wall of the case showing a section of the joint portions according to a twelfth exemplary embodiment.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments maybe modified in various different ways, all without departing from the spirit or scope of the present invention. The drawings and description are to be regarded as illustrative in nature and not restrictive. Like reference numerals designate like elements throughout the specification.

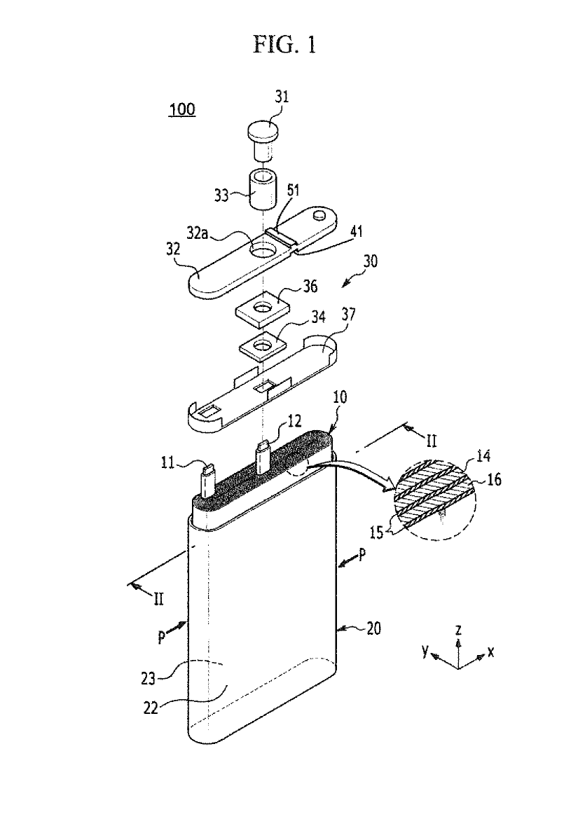

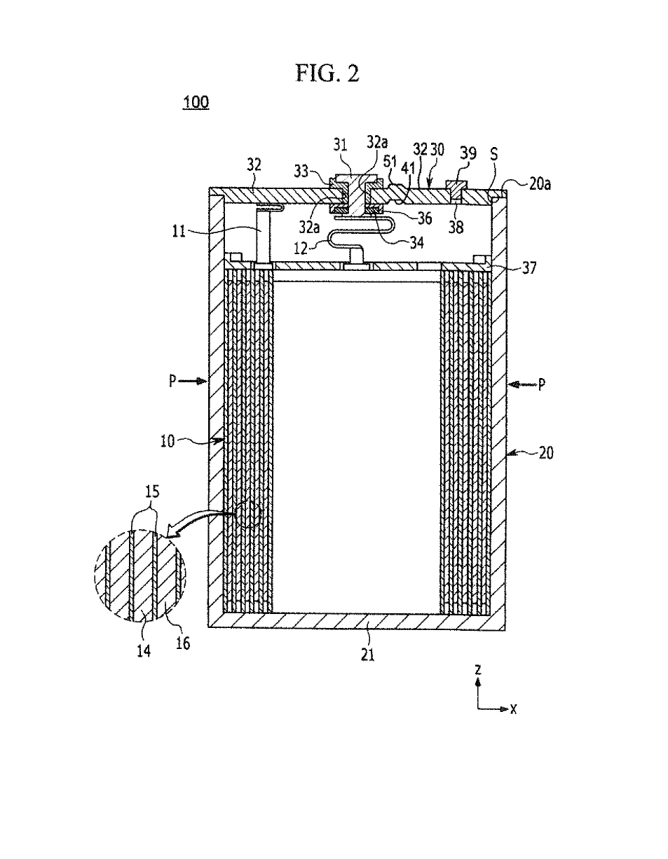

Turning now to FIGS. 1 and 2, FIG. 1 shows an exploded perspective view of a rechargeable battery 100 according to a first exemplary embodiment, and FIG. 2 shows a cross-sectional view with respect to a line II-II when a rechargeable battery 100 of FIG. 1 is assembled. Referring to FIG. 1 and FIG. 2, the rechargeable battery 100 includes an electrode assembly 10 for charging and discharging a current, a case 20 to accommodate the electrode assembly 10 and an electrolyte solution, and a cap assembly 30 to seal an upper opening of the case 20.

The electrode assembly 10 is formed by stacking a positive electrode 14, a separator 15 a negative electrode 16 and another separator 15 and spiral-winding the same in a jelly-roll, the separators being electrical insulators. The electrode assembly 10 may have a shape that corresponds to an inner space, of for example a squared case 20 so that the electrode assembly 10 may be inserted into the case 20.

The case 20 receives the electrode assembly 10 through an opening arranged at one side, and is made out of a conductor so that it may function as an electrode terminal. For example, the case 20 may be made out of aluminum or an aluminum alloy, and may be electrically connected to the positive electrode 14 of the electrode assembly 10 so that the case 20 can serve as a positive electrode terminal. Case 20 has a bottom wall 21 opposite an opening, and a front sidewall 22 opposite a back sidewall 23. Front and back sidewalls 22 and 23 are the largest sidewalls of the case, and are connected together by curved portions on either side.

When case 20 serves as a positive electrode terminal, the electrode terminal 31 installed in the cap assembly 30 is electrically connected to the negative electrode 16 of the electrode assembly 10 to serve as a negative electrode terminal. Alternatively, the case 20 may instead serve as a negative electrode terminal and the electrode terminal 31 may instead serve as a positive electrode terminal.

The cap assembly 30 includes a cap plate 32 fixed to the opening of the case 20, an electrode terminal 31 including an insulating gasket 33 and inserted into a terminal hole 32a of the cap plate 32, a terminal plate 34 electrically connected to the electrode terminal 31, an insulating plate 36 provided between the cap plate 32 and the terminal plate 34, an insulating case 37 provided between the electrode assembly 10 and the cap assembly 30, and a sealing cap 39 installed in an electrolyte injection opening 38 of the cap plate 32. Cap plate 32 may be welded to case 20 along surface S or 20a.

The insulating gasket 33 electrically insulates the electrode terminal 31 from the cap plate 32 and seals a gap between them. The insulating plate 36 electrically insulates the terminal plate 34 from the cap plate 32 and seals a gap between them. The insulating case 37 electrically insulates the electrode assembly 10 from the cap assembly 30.

The electrolyte injection opening 38 combines the cap plate 32 and the insulating case 37 to allow the electrolyte solution to be injected from an outside and into the case 20. After the electrolyte solution is injected, the electrolyte injection opening 38 is sealed with a sealing cap 39.

A positive electrode lead 11 fixed to the positive electrode 14 of the electrode assembly 10 is welded inside the cap plate 32 to transmit the voltage of the positive electrode 14 to the cap plate 32 and the case 20. That is, the case 20 functions as a positive electrode terminal. The insulating case 37 insulates the negative electrode 16 of the electrode assembly 10 from the cap plate 32 that has a positive polarity.

A negative electrode lead 12 fixed to the negative electrode 16 of the electrode assembly 10 is welded on the bottom of the terminal plate 34 to transmit the voltage of the negative electrode 16 to the terminal plate 34 and the electrode terminal 31. That is, the electrode terminal 31 serves as a negative electrode terminal.

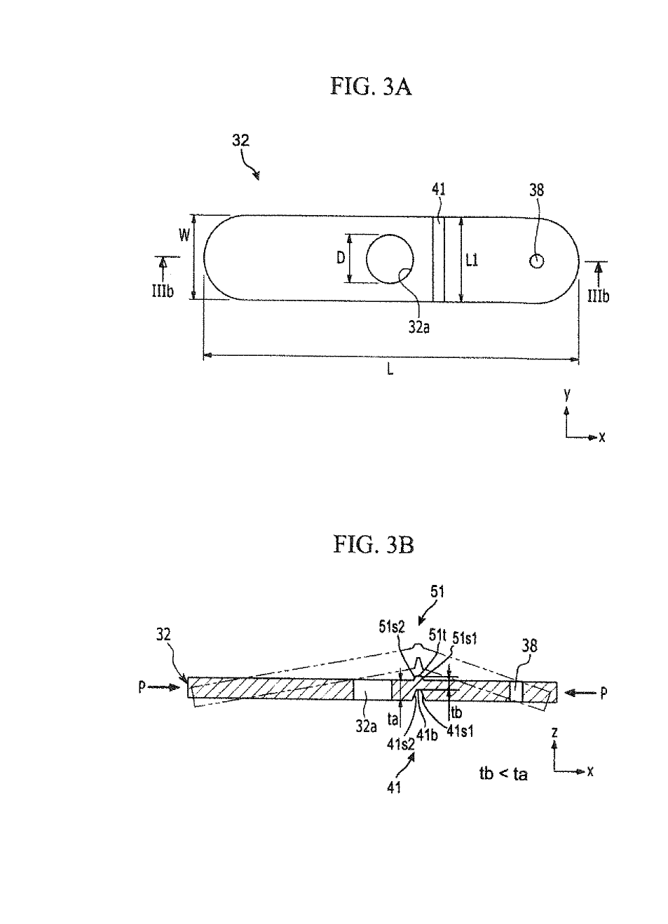

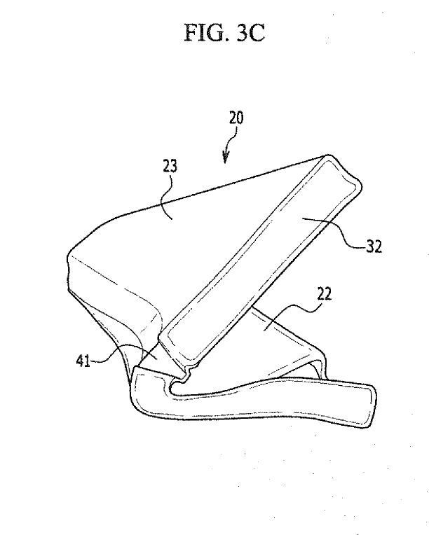

Turning now to FIGS. 3A to 3C, FIG. 3A shows a bottom plan view of a cap plate 32 applicable to a rechargeable battery 100 of FIG. 1, FIG. 3B shows a cross-sectional view of cap plate 32 with respect to a line of FIG. 3A, and FIG. 3C shows a perspective view of the rechargeable battery 100 according to a first exemplary embodiment upon being deformed by longitudinal compression.

Referring now to FIG. 3A to FIG. 3C, cap plate 32 has a length L and a width W, the width W extending from a front sidewall 22 to a back sidewall 23 of the case 20. The length direction (i.e. x-axis direction) is the longer dimension of the cap plate 32 and the width direction (i.e., y-axis direction) is the shorter dimension of the cap plate. As a result, it can be said that L>W, and preferably L>>W.

A bottom side of the cap plate 32 includes a straight bend inducing groove 41 that extends in the y-axis direction that crosses the x-axis direction in which the longitudinal compression (P) force is applied. The bend inducing groove 41 is arranged on a bottom side of the cap plate 32 so that the groove 41 faces the electrode assembly 10 and the corresponding protrusion 51 is on the top side of cap plate 32 and faces away from electrode assembly 10. The bend inducing groove 41 induces bending of the cap plate 32 under the longitudinal compression condition. In the first exemplary embodiment, the bend inducing groove 41 is arranged between the terminal hole 32a and the electrolyte injection opening 38.

Referring now to FIG. 1 and FIG. 2, the longitudinal compression (P) works on the sides of the cap plate 32 and curved sidewalls of the case 20 to bend or fold the case 20 toward the front sidewall 22 or the back sidewall 23. For convenience, FIG. 3C shows the case 20 being folded with the front sidewall 22 as the inside and the back sidewall 23 as the outside. In this instance, the bend inducing groove 41 arranged in the cap plate 32 fluently induces bending of the cap plate 32 following the transformation of the case 20 to thus prevent hindrance of bending or folding of the case 20 caused by an otherwise bad bending of the cap plate 32. In FIG. 3C, the cap plate is separated at the bend inducing groove 41 to allow the cap plate 32 to be easily bent and the case 20 to be easily folded.

Referring now to FIG. 3A and FIG. 3B, the terminal hole 32a is arranged at the center of the length (L) direction (set in the x-axis direction) of the cap plate 32 and has a diameter (D) that corresponds to the insulating gasket 33. The bend inducing groove 41 is arranged near the terminal hole 32a. Upon the longitudinal compression (P) condition, the case 20 is bent or folded near the center of the width direction (i.e., the x-axis direction) since the bend inducing groove 41 is arranged near the terminal hole 32a. Bend inducing groove 41 is placed as reasonably close to terminal hole 32a as possible as long as bend inducing groove 41 is not too close so that it may interfere with the installation of the electrode terminal 31 in the terminal hole 32a of the cap plate 32.

The bend inducing groove 41 provides a location in the cap plate having a low mechanical strength upon the longitudinal compression (P) condition in the cap plate 32, and it is designed to have a groove having depth (tb) that is less than the thickness (ta) of the cap plate 32 (refer to FIG. 3B). Therefore, the cap plate 32 can be bent at the bend inducing groove 41 upon application of the longitudinal compression (P) force.

Also, the bend inducing groove 41 is arranged near the terminal hole 32a and has a mechanical strength that is weaker than that of the terminal hole 32a. This is because bend inducing groove 41 has a length L1 that is greater than the diameter (D) of the terminal hole 32a in the width (W) direction (i.e., the y-axis direction) of the cap plate 32 (refer to FIG. 3A.) As a result, the cap plate 32 can be bent at the bend inducing groove 41 and not at the terminal hole 32a upon application of the longitudinal compression (P).

As illustrated in FIG. 3B, by having the bend inducing groove 41 on a bottom side of the cap plate 32 and facing the electrode assembly 10, the electrode assembly 10 is less apt to be damaged upon application of a compressive force P to the case 20 of the battery 100. This is because the groove 41 on the bottom side of the cap plate 32 causes the cap plate to bulge upwards and away from the electrode assembly 10 upon application of a compressive force P, thereby preventing the cap plate 32 from contacting or interfering with the electrode assembly 10. In modern rechargeable batteries having increased capacity in a smaller space, the distance between the cap plate 32 and the electrode assembly 10 can be very minute. If the battery is compressed by a compression force P, because of this very small distance between the electrode assembly 10 and the cap plate 32, the electrode assembly is apt to be damaged because it can be pierced by the cap plate 32. Consequently, by including such a groove 41 in the bottom surface of cap plate 32, the electrode assembly 10 is protected from being shorted by the cap plate 32 upon an application of a compressive force P because the groove 41 in the bottom surface of the cap plate causes the cap plate 32 to bend in a direction away from the electrode assembly 10, leaving the electrode assembly 10 undamaged.

As illustrated in FIG. 3B, groove 41 may have a bottom surface 41b and opposing side surfaces 41s1 and 41s2. Because side 41s1 is spaced-apart from opposing surface 41s2, and because the groove 41 is arranged on a bottom side of cap plate 32, a compressive force P on battery 100 and on cap plate 32 causes the cap plate 32 to bulge upwards and away from the electrode assembly 10.

On a top surface of the cap plate is a protrusion 51 that corresponds to groove 41. Protrusion or ridge 51 may have side surfaces 51s1 and 51s2 and a top surface 51t. It may be possible to produce the groove 41/protrusion 51 arrangement in cap plate 31 by a pressing process.

In the embodiment of FIG. 3A, the length L1 of the bend inducing groove 41 is the same size as the width (W) of the cap plate 32. That is, the bend inducing groove 41 extends over the entire width (W) of the cap plate 32 so bending of the cap plate 32 can be induced over the width (W) of bend inducing groove under the longitudinal compression (P) condition.

Accordingly, when the case 20 is bent or folded by the longitudinal compression (P), bending of the cap plate 32 is induced in the direction in which the bend inducing groove 41 is oriented so that an internal short circuit of the cell can be prevented. That is, the internal short circuit of the cell that may occur when the cap plate 32 is not bent or is bent in a random direction due to bending resistance being prevented under the longitudinal compression (P) condition. As a result, the presence of bend inducing groove serves to prevent the rechargeable battery 100 from burning or exploding and prevents the electrode assembly 10 from being damaged or shorted.

Various exemplary embodiments will now be described where the number, length, orientation etc of the bend inducing groove in the cap plate varies. In the descriptions thereof, portions that are the same configuration as In the first exemplary embodiment will be omitted while differences between the first exemplary embodiment will be emphasized through comparison.

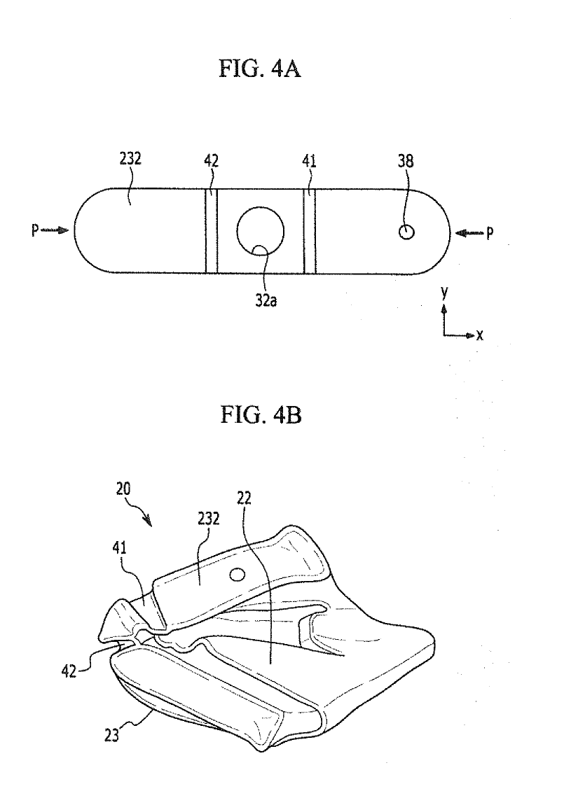

Turning now to FIGS. 4A and 4B, FIG. 4A shows a bottom plan view of a cap plate 232 applicable to a rechargeable battery according to a second exemplary embodiment, and FIG. 4B shows a perspective view of a rechargeable battery according to a second exemplary embodiment under a longitudinal compression condition. In the first exemplary embodiment, the cap plate 32 includes a bend inducing groove 41 arranged on one side of the terminal hole 32a. In the second exemplary embodiment, the cap plate 232 includes bend inducing grooves 41 and 42 on both sides of the terminal hole 32a. In the second exemplary embodiment, one bend inducing groove 41 is arranged between the terminal hole 32a and the electrolyte injection opening 38 and the other bend inducing groove 42 is arranged on an opposite side with the terminal hole 32a than the first bend inducing groove 41.

In the second exemplary embodiment, the cap plate 232 includes bend inducing grooves 41 and 42 on both sides of the terminal hole 32a in a symmetric manner, so it can induce bending of the cap plate 232 on one or both sides of the terminal hole 32a under the longitudinal compression (P) condition. That is, the internal short circuit of the cell is more efficiently prevented under the longitudinal compression (P) condition.

For convenience, in FIG. 4B, the bend inducing grooves 41 and 42 induce bending of the cap plate 32 on both sides of the terminal hole 32a. In this instance, the case 20 is bent with the front sidewall 22 as the inside and the back sidewall 23 as the outside.

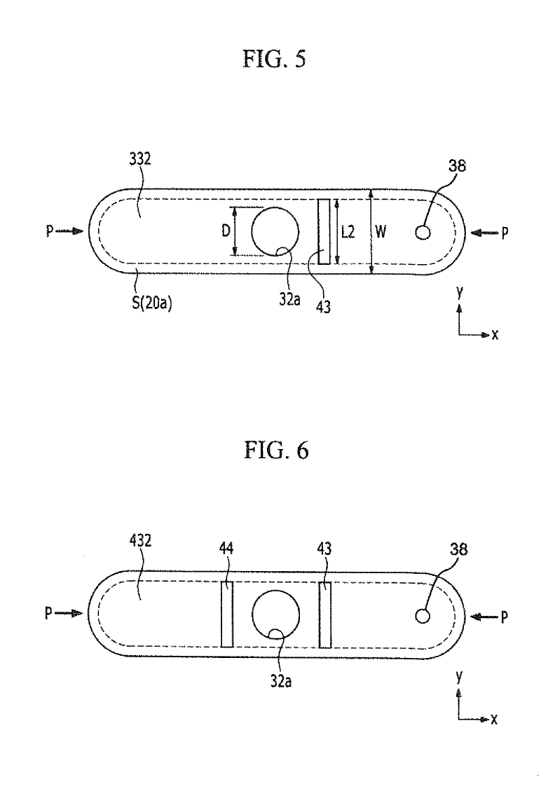

Turning now to FIG. 5, FIG. 5 shows a bottom plan view of a cap plate 332 applicable to a rechargeable battery according to a third exemplary embodiment. In the first exemplary embodiment, the cap plate 32 includes the bend inducing groove 41 that extends the entire width direction (i.e., the y-axis direction) of the cap plate 32. In the third exemplary embodiment, the cap plate 332 includes a bend inducing groove 43 that extends only a portion of the width (W) that is set in the width direction (i.e., the y-axis direction) of the cap plate 332.

In the third exemplary embodiment, the cap plate 332 includes the bend inducing groove 43 on one side of the terminal hole 32a with a length L2 that is smaller than the width (W) of the cap plate 332, and it induces bending of the cap plate 332 on one side of the terminal hole 32a under the longitudinal compression (P) condition. For this purpose, the bend inducing groove 43 arranged on a part of the width (W) of the cap plate 332 is set with the length L2 that is greater than the diameter (D) of the terminal hole 32a, and covering the center of the width direction (i.e., the y-axis direction).

In the embodiment of FIG. 5, the bend inducing groove 43 is arranged so that it does not intersect or interfere with welding surface (S) of the cap plate 332. As a result, by shortening a length L2 of groove 43 so that it does not extend into welding surface S (20a) used to weld cap plate 332 to case 20, the welding process between the cap plate 332 and the case 20 is made easier and the strength of the weld between the cap plate 332 and the case 20 can be improved. Therefore, the advantage of the shorter bend inducing groove 43 is that it does not interfere with the welding between the welding surface S of cap plate 332 and case 20, allowing for a stronger and easier welding process.

Turning now to FIG. 6, FIG. 6 shows a bottom plan view of a cap plate 432 applicable to a rechargeable battery according to a fourth exemplary embodiment. In the third exemplary embodiment, the cap plate 332 includes the bend inducing groove 43 on one side of the terminal hole 32a. In the fourth exemplary embodiment, the cap plate 432 includes bend inducing grooves 43 and 44 on both sides of the terminal hole 32a.

In the fourth exemplary embodiment, the cap plate 432 includes the bend inducing grooves 43 and 44 on both sides of the terminal hole 32a in a symmetric manner so it induces bending of the cap plate 432 on one or both sides of the terminal hole 32a under the longitudinal compression (P) condition. That is, the bend inducing grooves 43 and 44 can more efficiently prevent the internal short circuit of the cell under the longitudinal compression (P) condition. Like the third embodiment of FIG. 5, the bend inducing grooves 43 and 44 in FIG. 6 are short so that they do not interfere with or intersect welding surface S (20a) shown by the dotted line. As with the first embodiment of FIG. 3A, each of bend inducing grooves 43 and 44 are arranged on a bottom side of the cap plate 432 so that a compressional force P causes the cap plate 432 to bend away from the electrode assembly 10 so that a short does not occur in the electrode assembly upon application of the compressional force P.

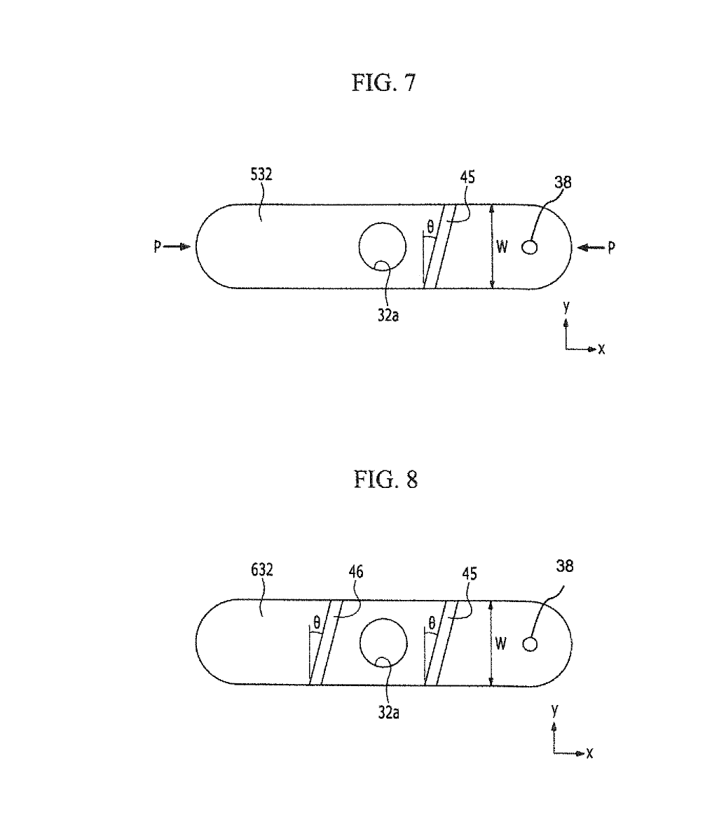

Turning now to FIG. 7, FIG. 7 shows a bottom plan view of a cap plate 532 applicable to a rechargeable battery according to a fifth exemplary embodiment. In the first exemplary embodiment, the cap plate 32 includes a bend inducing groove 41 in the width (W) direction (i.e., the y-axis direction) on one side of the terminal hole 32a. In the fifth exemplary embodiment, the cap plate 532 includes a bend inducing groove 45 so that it may have an inclination angle (θ) with respect to the width (W) direction (i.e., the y-axis direction) on one side of the terminal hole 32a. As with the first embodiment of FIG. 3A, bend inducing groove 45 is arranged on a bottom side of the cap plate 532 so that a compressional force P causes the cap plate 532 to bend away from the electrode assembly 10 so that a short does not occur in the electrode assembly 10 upon application of the compressional force P.

In the fifth exemplary embodiment, the cap plate 532 includes the bend inducing groove 45 so that it may have an inclination angle (θ) with respect to the width direction (i.e., the y-axis direction) on one side of the terminal hole 32a, and it can induce bending of the cap plate 532 in the direction of the inclination angle (θ) on one side of the terminal hole 32a under the longitudinal compression (P) condition. The bend inducing groove 45 can efficiently induce bending of the cap plate 532 when the longitudinal compression (P) is digressed from the x-axis direction by some degree.

Turning now to FIG. 8, FIG. 8 shows a bottom plan view of a cap plate 632 applicable to a rechargeable battery according to a sixth exemplary embodiment. In the fifth exemplary embodiment, the cap plate 532 includes a bend inducing groove 45 on one side of the terminal hole 32a. In the sixth exemplary embodiment, the cap plate 632 includes the bend inducing grooves 45 and 46 on both sides of the terminal hole 32a.

In the sixth exemplary embodiment, the cap plate 632 includes bend inducing grooves 45 and 46 on both sides of the terminal hole 32a in a symmetric manner with the inclination angle (θ) so it can induce bending of the cap plate 632 in the direction of the inclination angle (θ) on both or one side of the terminal hole 32a under the longitudinal compression (P) condition. The bend inducing grooves 45 and 46 can efficiently induce bending of the cap plate 632 on both sides of the terminal hole 32a when the longitudinal compression (P) is digressed from the x-axis direction by some degree.

Turning now to FIG. 9, FIG. 9 shows a bottom plan view of a cap plate 732 applicable to a rechargeable battery according to a seventh exemplary embodiment. In the fifth exemplary embodiment, the cap plate 532 includes the bend inducing groove 45 as a straight line with an inclination angle (θ) with respect to the width (W) direction (i.e., the y-axis direction). In the seventh exemplary embodiment, the cap plate 732 includes a V-shaped (or chevron-shaped) bend inducing groove 47 as a symmetric bent line with an inclination angle (θ) and a bend angle (θ1) with respect to the width direction (i.e., the y-axis direction).

In the seventh exemplary embodiment, the cap plate 732 includes a “V”-shaped bend inducing groove 47 as a bent line with an inclination angle (θ) and a bend angle (θ1) on one side of the terminal hole 32a so it can induce bending of the cap plate 632 in the bent line direction on one side of the terminal hole 32a under the longitudinal compression (P) condition.

The V-shaped bend inducing groove 47 can induce various bends of the cap plate 732 by the bend angle (θ1) with respect to the length (L) direction (i.e., the x-axis direction) and the width (W) direction (i.e., the y-axis direction) under the longitudinal compression (P) condition. As with the first embodiment of FIG. 3A, bend inducing groove 47 is arranged on a bottom side of the cap plate 732 so that a compressional force P causes the cap plate 732 to bend away from the electrode assembly 10 so that a short does not occur in the electrode assembly 10 upon application of the compressional force P.

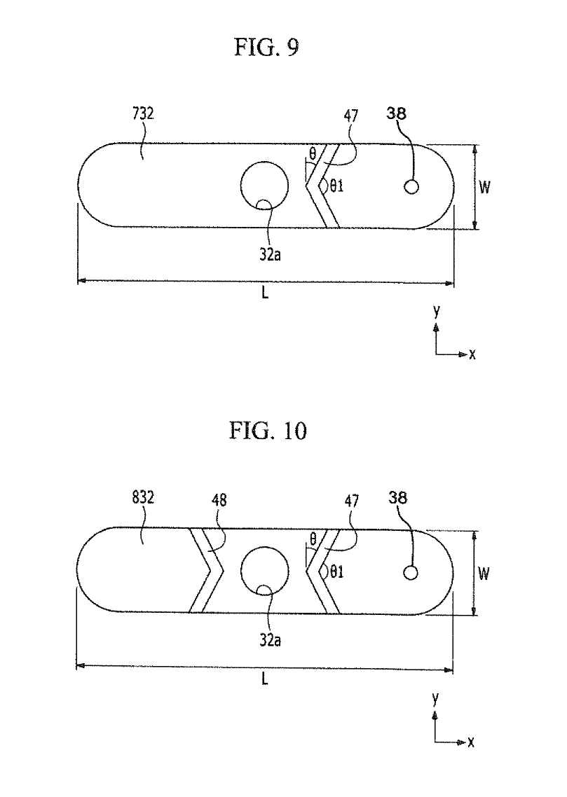

Turning now to FIG. 10, FIG. 10 shows a bottom plan view of a cap plate 832 applicable to a rechargeable battery according to a eighth exemplary embodiment. In the seventh exemplary embodiment, the cap plate 732 includes the V-shaped bend inducing groove 47 on one side of the terminal hole 32a. In the eighth exemplary embodiment, the cap plate 832 includes the V-shaped bend inducing grooves 47 and 48 on both sides of the terminal hole 32a.

In the eighth exemplary embodiment, the cap plate 832 includes the V-shaped bend inducing grooves 47 and 48 as bent lines with an inclination angle (θ) and a bend angle (θ1) on both sides of the terminal hole 32a, and can induce bending of the cap plate 832 in the bent line direction on both or one side of the terminal hole 32a under the longitudinal compression (P) condition.

The bend inducing grooves 47 and 48 can induce various types of bending of the cap plate 832 in the length (L) direction (i.e., the x-axis direction) and the width (W) direction (i.e., the y-axis direction) by the bend angle (θ1) on both sides of the terminal hole 32a under the longitudinal compression (P) condition.

In the embodiment of FIGS. 9 and 10, θ1 is the angle at the apex of groove 47 and 48. In the embodiments of FIGS. 9 and 10, the apexes point towards the terminal hole 32a. Although it can be said that θ1=180°−2 θ, the present invention is in no way so limited.

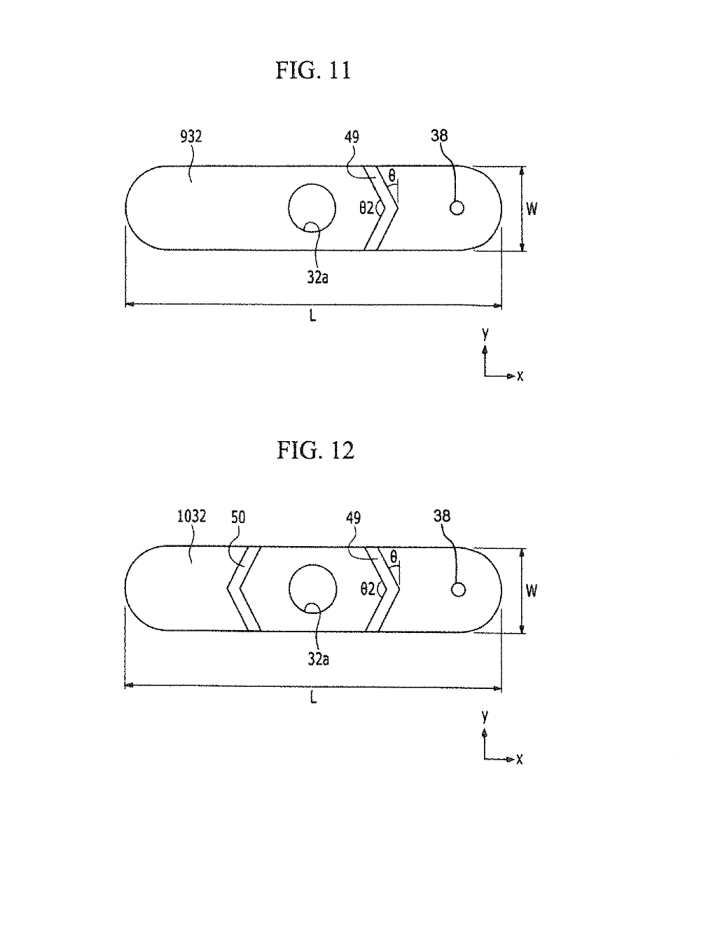

Turning now to FIG. 11, FIG. 11 shows a bottom plan view of a cap plate 932 applicable to a rechargeable battery according to a ninth exemplary embodiment. In the seventh exemplary embodiment, the cap plate 732 has the V-shaped bent line with the protruding direction of the bend inducing groove 47 toward the terminal hole 32a (i.e., pointing towards terminal hole 32a). In the ninth exemplary embodiment, the cap plate 932 has a V-shaped bent line with the protruding direction of the bend inducing groove 49 pointing away from terminal hole 32a. That is, the bend inducing groove 49 is formed in a state in which the bent line receives the terminal hole 32a.

In the ninth exemplary embodiment, the cap plate 932 includes the V-shaped bend inducing groove 49 as a bent line with an inclination angle (θ) and a bend angle (θ2) on one side of the terminal hole 32a, and can induce bending of the cap plate 932 in the bent line direction on one side of the terminal hole 32a under the longitudinal compression (P) condition.

The V-shaped bend inducing groove 49 can induce various kinds of bending of the cap plate 932 by the bend angle (θ2) in the length (L) direction (i.e., the x-axis direction) and the width (W) direction (i.e., the y-axis direction) under the longitudinal compression (P) condition.

In the seventh exemplary embodiment, the V-shaped bend inducing groove 47 has the protruding direction that is formed with the inclination angle (θ) and the bend angle (θ1) that points toward the terminal hole 32a. Therefore, in the seventh exemplary embodiment, the bend inducing groove 47 can induce convex bending of an adjacent side of the terminal hole 32a by the bend angle (θ1) in the width direction (i.e., the y-axis direction) of the cap plate 732.

In the ninth exemplary embodiment, the bend inducing groove 49 is formed with the protruding direction that is formed with an inclination angle (θ) and a bend angle (θ2) on the opposite side of the terminal hole 32a. Therefore, in the ninth exemplary embodiment, the bend inducing groove 49 can induce convex bending of a remote side of the terminal hole 32a by the bend angle (θ2) with respect to the width direction (i.e., the y-axis direction) of the cap plate 932.

As with the first embodiment of FIG. 3A, bend inducing groove 49 is arranged on a bottom side of the cap plate 932 so that a compressional force P causes the cap plate 932 to bend away from the electrode assembly 10 so that a short does not occur in the electrode assembly 10 upon application of the compressional force P.

Turning now to FIG. 12, FIG. 12 shows a bottom plan view of a cap plate 1032 applicable to a rechargeable battery according to a tenth exemplary embodiment. In the ninth exemplary embodiment, the cap plate 932 includes the V-shaped bend inducing groove 49 on one side of the terminal hole 32a. In the tenth exemplary embodiment, the cap plate 1032 includes V-shaped bend inducing grooves 49 and 50 on both sides of the terminal hole 32a.

In the tenth exemplary embodiment, the cap plate 1032 includes the bend inducing grooves 49 and 50 as bent lines with an inclination angle (θ) and a bend angle (θ2) on both sides of the terminal hole 32a, and can induce bending of the cap plate 1032 in the bent line direction on both or one side of the terminal hole 32a under the longitudinal compression (P) condition.

The bend inducing grooves 49 and 50 can induce various sorts of bends in the cap plate 1032 in the length (L) direction (i.e., the x-axis direction) and the width (W) direction (i.e., the y-axis direction) by the bend angle (θ2) on both sides of the terminal hole 32a under the longitudinal compression (P) condition.

In the embodiment of FIGS. 11 and 12, θ2 is the angle at the apex of groove 49 and 50. In the embodiments of FIGS. 11 and 12, the apexes point towards the terminal hole 32a. Although it can be said that θ2=180°−2 θ, the present invention is in no way so limited.

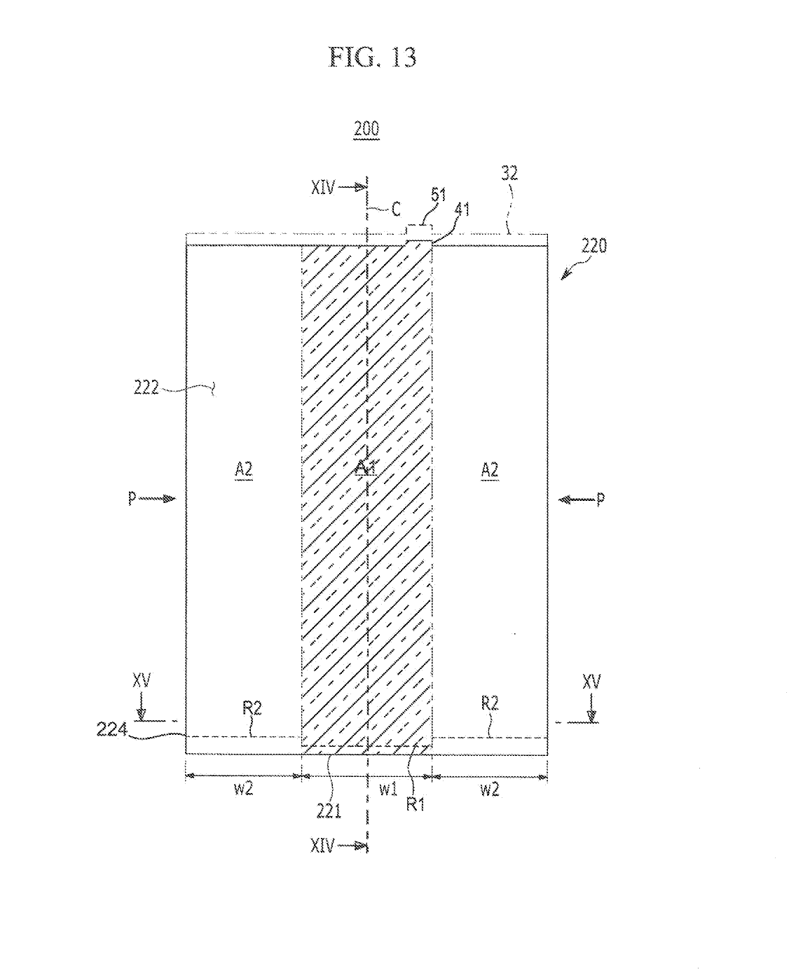

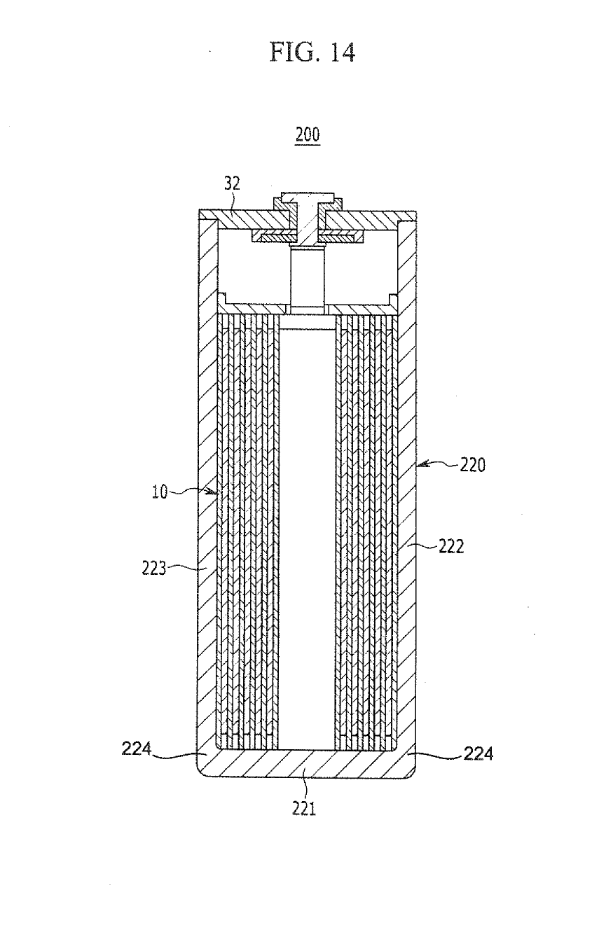

Turning now to FIGS. 13 through 17, FIGS. 13 through 17 are views of a rechargeable battery 200 according to an eleventh exemplary embodiment of the present invention. Referring now to FIGS. 13 and 14, FIG. 13 is a front view of case 220 of rechargeable battery 200 according to the eleventh embodiment, and FIG. 14 shows a cross-sectional view with respect to a line XIV-XIV of FIG. 13. Referring to FIG. 13 and FIG. 14, the case 220 is formed to be a shape of a rectangle including an opening, a bottom wall 221 provided on the opposite side of the opening, a front sidewall 222 for surrounding a front part between the opening and the bottom wall 221, and a back sidewall 223 for surrounding a back part, and joint portions 224 joining the bottom wall 221 to each of the front and back sidewalls 222 and 223 respectively, the case 220 providing a receiving space for the electrode assembly 10. The case 220 according to the eleventh exemplary embodiment is designed to prevent damage to the electrode assembly 10 upon a longitudinal compression condition. In FIG. 13, the direction of the longitudinal compression (P) is applied to the right and left sides of the case 220.

For example, the case 220 is produced by deep drawing or pressing process, and it is produced by connecting the bottom wall 221 to the front sidewall 222 via a joint portion 224, which is a curved surface, and connecting the bottom wall 221 to the back sidewall 223 via another joint portion 224.

The case 220 according to the eleventh exemplary embodiment is formed to induce the bent or folded position of the case 220 at a predetermined location in order to prevent an internal short circuit within the electrode assembly 10 upon the longitudinal compression condition (P), and to enhance the ability to bend the battery and the location of the bend according to the grooves in the cap plate according to the first ten embodiments of the present invention by providing further weakness to the battery at a portion of the case that corresponds to the grooves in the cap plate upon application of compressive force P.

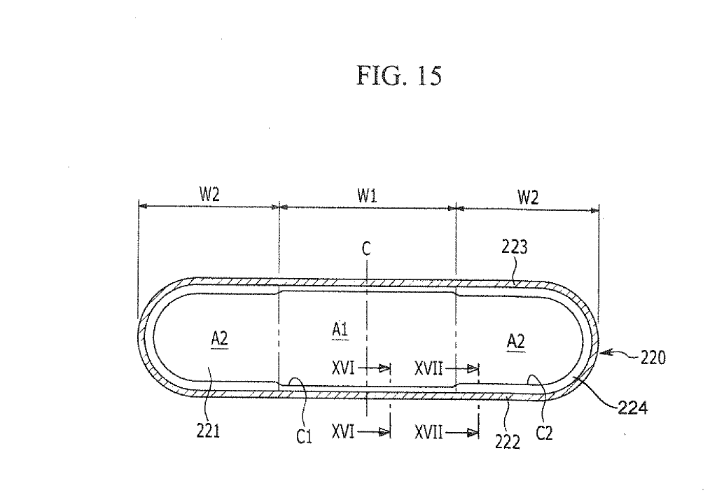

Turning now to FIG. 15, FIG. 15 shows a cross-sectional view of a case with respect to a line XV-XV of FIG. 13, showing sections joint portions 224 of case 220 of FIG. 13. Referring to FIGS. 13 and 15, the case 220 is designed to have different mechanical strengths at different locations for the longitudinal compression condition (P). That is, the case 220 includes a first area A1 at a center having a low mechanical strength for the longitudinal compression condition (P) and a second area A2 at both ends having a relatively higher mechanical strength than the first area A1.

The first area A1 has a first width W1 that extends through the center line (C) of the case 220. The second areas A2 each have second widths W2 and are arranged on opposite sides of the first area A1. In the eleventh embodiment of FIGS. 13 through 15, the first area A1 and the second areas A2 are symmetric with respect to the center line (C) in the case 220. In the eleventh embodiment, the bend inducing groove 41 of the cap plate 32 may be arranged to correspond to an edge of the first area A1 where the first area A1 and the second area A2 meet as illustrated in FIG. 13.

In the eleventh embodiment of FIGS. 13 through 15, the case 220 has different curvatures for the internal curved surfaces of the joint portions 224 that connect the bottom wall 221 to each of the front and back sidewalls 222 and 223, these different curvatures correspond to first and second areas A1 and A2. Also in the eleventh embodiment of FIGS. 13 through 15, the joint portions 224 of case 220 between bottom wall 221 and each of front and back sidewalls 222 and 223 has different thicknesses according to the first and second areas A1 and A2.

The profile of the curved surface of the joint portion 224 connecting the bottom wall 221 to the front sidewall 222 is identical that of the curved surface of the other joint portion 224 connecting the bottom wall 221 to the back sidewall 223. As a result, only the joint portion 224 connecting the bottom wall 221 to the front sidewall 222 will now be discussed.

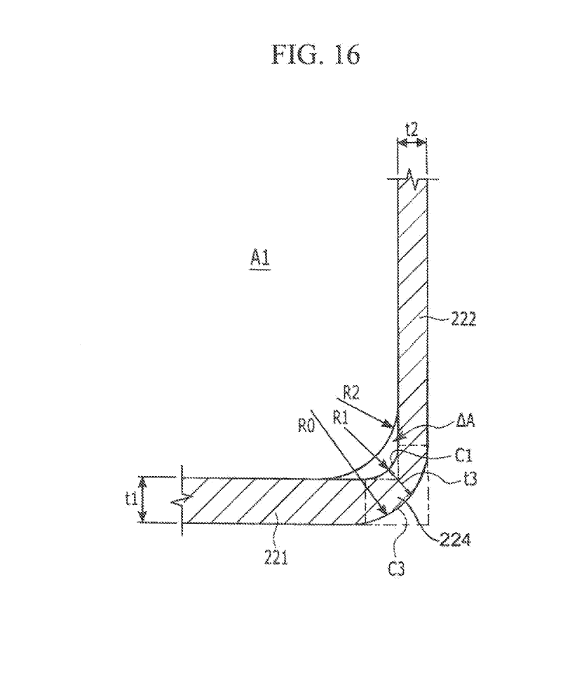

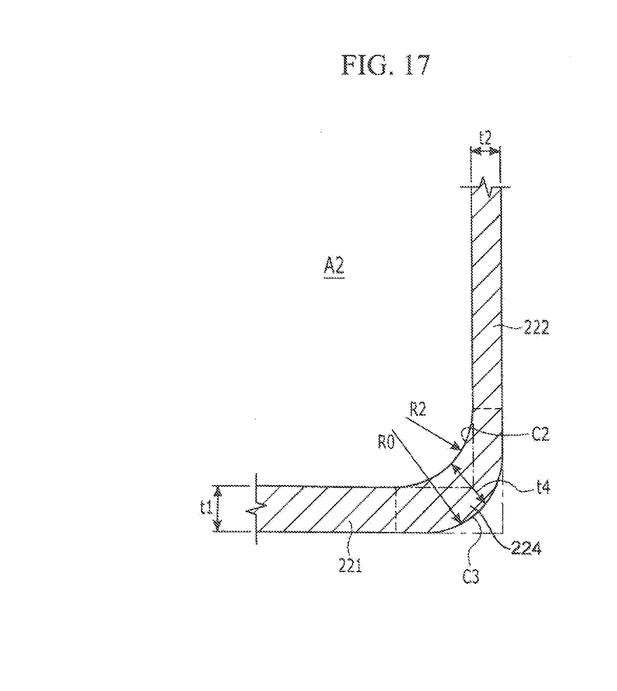

Turning now to FIGS. 16 and 17, FIG. 16 shows a cross-sectional view with respect to a line XVI-XVI of FIG. 15, which shows a shows a profile of a joint portion 224 connecting the bottom wall 221 to the front sidewall 222 in central region A1, and FIG. 17 shows a cross-sectional view with respect to a line XVII-XVII of FIG. 15, which shows a profile of the same joint portion 224 connecting the bottom wall 221 to the front sidewall 222 but in a side region A2. Referring to both of FIG. 16 and FIG. 17, a first thickness t1 of the bottom wall 221 is formed to be greater than a second thickness (t2) of the front sidewall 222 (i.e., t1>t2) in each of areas A1 and A2 (where the thickness of the back sidewall is the same as the thickness of the front sidewall). In addition, it is further noted that a thickness (t2) of front sidewall 222 in first area A1 is the same as a thickness t2 of front sidewall 222 in second area A2, which is also the same as the thickness t2 of the back sidewall 223 in each of areas A1 and A2, and that it is only the thickness of the joint portions 224 that vary between first area A1 and second areas A2.

Therefore, the case 220 having mechanical strength can induce bending or folding depending on the mechanical strength of the joint portions 224 without being influenced by the mechanical strength of the bottom wall 221 or the front and back sidewalls 222 and 223 under the longitudinal compression condition. That is, the case 220 can induce bending in the first area A1 that is weak compared to the second area A2. For example, the first thickness t1 of the bottom wall 221 is 0.4 mm and the second thickness t2 of the front sidewall 222 is 0.25 mm.

Referring to FIG. 13 and FIG. 15 to FIG. 17, the interior curved surface C1 of the joint portion 224 connecting the bottom wall 221 to the front sidewall 222 in the first area A1 has a first radius of curvature R1 that is smaller than the radius of curvature R2 of an interior curved surface C2 of the joint portion 224 connecting the bottom wall 221 to the front sidewall 222 in the second areas A2. Because curvature is proportional to the reciprocal of the radius of curvature (i.e., C1=k/R1 and C2=k/R2, where k is a constant), it can also be said that the curvature C1 of the interior curved surface of portions of the joint portions 224 within first area A1 is greater than the curvature C2 of the interior curved surface of portions of the joint portions 224 within second areas A2. And because it may be possible that the interior surfaces of the joint portions 224 may not trace out an arc of a perfect circle and thus may not have a radius in the traditional sense, curvatures as opposed to radii of curvatures may be compared to each other.

The first and second radii of curvature R1 and R2 are interior radii of curvatures of the curved surfaces C1 and C2 on the inside surface of the joint portions 224 of case 220 in the first and second areas A1 and A2 respectively. The exterior radius of curvature radius R0 of the exterior curved surface C3 connecting the bottom wall 221 to the front sidewall 222 is the same in both the first and second areas A1 and A2.

As a result, a distance between interior curved surface C1 and exterior curved surface C0 is t3, which is the thickness of the joint portion 224 connecting the bottom wall 221 to the front sidewall 222 of case 220 in first area A1. A distance between interior curved surface C2 and exterior curved surface C0 is t4, which is the thickness of the joint portion 224 connecting the bottom wall 221 to the front sidewall 222 of case 220 in second area A2. The third and fourth thicknesses t3 and t4 are set to be between the first thickness t1 and the second thickness t2, and are gradually reduced toward the front sidewall 222 from the bottom wall 221. Also, it can be said that the thickness t4 of the joint portions 224 in the second area A2 is greater than the thickness t3 of the joint portions 224 in the first area A1 (i.e., t4>t3). For convenience, in FIG. 16 and FIG. 17, the third and fourth thicknesses t3 and t4 are shown at random positions in the joint portions 224.

Referring to FIG. 16, the curved surfaces C1 and C2 of the joint portion 224 connecting the bottom wall 221 to the front sidewall 222 in the first and second areas A1 and A2 have a cross-section difference (ΔA). That is, portions of the joint portions 224 in the second area A2 have greater mechanical strength than portions of the joint portions in first area A1 by the cross-section difference (ΔA). Therefore, bending can be induced in the first area A1 that is arranged about the center line (C) of the case 220 upon the longitudinal compression condition (P).

Accordingly, the rechargeable battery 200 that includes the cap plate 32 having the bend inducing groove 41 according to the first exemplary embodiment can be welded to the case 220 according to the eleventh exemplary embodiment to further induce bending or folding in a predetermined direction in the first area A1 of the case 220, thereby efficiently preventing the internal short circuit of the cell.

In addition to combining the cap plate 32 of the first embodiment with case 220 of the eleventh embodiment, the cap plate according to any of the second through to tenth exemplary embodiments can be welded to case 220 according to the eleventh exemplary embodiment of FIGS. 13 through 17. For convenience, the cap plate 32 according to the first exemplary embodiment has been described above as being applied to the eleventh exemplary embodiment.

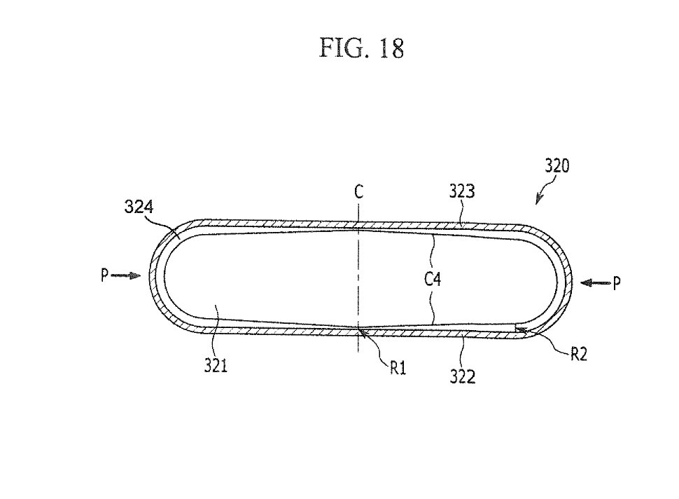

Turning now to FIG. 18, FIG. 18 shows a cross-sectional view of a case 320 applicable to a rechargeable battery according to a twelfth exemplary embodiment of the present invention. In the eleventh exemplary embodiment, the case 220 includes the first area A1 with the first radius of curvature R1 in the center of the width direction and includes the second area A2 with the second radius of curvature R2 on both sides of the first area A1.

The case 320 according to the twelfth exemplary embodiment has the first interior radius of curvature R1, the minimum curvature, in correspondence to the center line (C), and has the second interior radius of curvature R2, the maximum curvature, on both sides of center line C and furthest from center line C. The interior radius of curvature is linearly reduced toward the center line (C) from the both sides of the case 320 (i.e., it is gradually reduced to the first radius of curvature R1 from the second radius of curvature R2). Because curvature is inversely proportional to radius of curvature, it can alternatively be said that the curvature of the interior surface of the joint portions 324 are at a maximum at center line C and are gradually reduced with distance from center line C. Also, by comparing curvatures instead of radii of curvature, the present invention can be better expressed when the interior surfaces of the joint portions 324 do not trace out an arc of a perfect circle.

In the twelfth embodiment of FIG. 18, the cross-section difference (ΔA, refer to FIG. 16) that is set by the curved surface (C4) including the interior curved surface of the joint portion 324 connecting the bottom wall 321 to each of the back sidewall 323 and the front sidewall 322 is linearly reduced toward the center line (C) from both sides of the case 320. Therefore, the case 320 has the weakest mechanical strength at the center line (C) so it efficiently prevents the internal short circuit of the cell since it is bent or folded near the center line (C) upon the longitudinal compression condition (P).

The case 220 according to the eleventh exemplary embodiment can be bent at somewhat different positions depending on the conditions within the range of the first area A1 under the longitudinal compression condition (P), and the case 320 according to the twelfth exemplary embodiment sets the bending position more accurately since it is bent at the center line (C) upon the longitudinal compression condition (P).

Further, the case 320 can be modified so that the minimum first curvature radius R1 (i.e., maximum curvature C1) at a location that is spaced-apart from the center line (C), and in this instance, the bend inducing groove of the cap plate can be a straight line that is located where the case 320 has the first curvature radius R1 (not shown) between the bottom wall 321 and the front and back sidewalls 322 and 323.

In addition to combining the cap plate 32 of the first embodiment with case 320 of the twelfth embodiment, the cap plate according to any of the second through to tenth exemplary embodiments are applicable to case 320 according to the twelfth exemplary embodiment of FIG. 18 to further enhance the bending characteristics of the battery under a compressive force P. For convenience, the cap plate 32 according to the first exemplary embodiment has been described above as being applied to the twelfth exemplary embodiment.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery, comprising:
a case having a front sidewall opposite a back sidewall, a bottom wall opposite an opening and joint portions connecting the bottom wall to each of the front and back sidewalls, the front and back sidewalls and the corresponding joint portions of the case each having a center portion and side portions on either side of the center portion and extending from the opening to the bottom wall;
an electrode assembly arranged within the case;
a cap plate arranged within the opening of the case to seal within the electrode assembly, the cap plate including at least one bend inducing groove; and
an electrode terminal extending through the cap plate and being electrically connected to the electrode assembly, wherein a thickness of the front and back sidewalls of the case is less than a thickness of the bottom wall of the case, wherein a curvature of an inner curved surface of portions of the joint portions arranged within the center portion being greater than a curvature of an inner curved surface of portions of the joint portions arranged within the side portions.

2. The rechargeable battery of claim 1, the cap plate having a long length direction and a relatively shorter width direction that extends from the back sidewall to the front sidewall of the case, the cap plate being perforated by a terminal hole at a center of the cap plate through which the electrode terminal extends, the cap plate also being perforated by an electrolyte injection hole.

3. The rechargeable battery of claim 2, the at least one bend inducing groove being arranged between the electrolyte injection hole and the terminal hole and extending an entire width of the cap plate in the width direction.

4. The rechargeable battery of claim 2, the at least one bend inducing groove being arranged between the electrolyte injection hole and the terminal hole and extending only a portion of a width of the cap plate in the width direction.

5. The rechargeable battery of claim 2, the at least one bend inducing groove comprising two bend inducing grooves, one on either side of the terminal hole and extending an entire width of the cap plate in the width direction.

6. The rechargeable battery of claim 2, the at least one bend inducing groove comprising two bend inducing grooves, one on either side of the terminal hole and extending only a portion of a width of the cap plate in the width direction.

7. The rechargeable battery of claim 2, the at least one bend inducing groove being arranged between the electrolyte injection hole and the terminal hole and extending in a direction that forms an angle with the width direction of the cap plate.

8. The rechargeable battery of claim 2, the at least one bend inducing groove comprising two bend inducing grooves, one on either side of the terminal hole and extending in a direction that forms an angle with the width direction of the cap plate.

9. The rechargeable battery of claim 2, the at least one bend inducing groove being arranged between the electrolyte injection hole and the terminal hole and having a “V” shape, an apex of the “V”-shaped groove pointing towards the terminal hole.

10. The rechargeable battery of claim 2, the at least one bend inducing groove comprising two bend inducing grooves, one on either side of the terminal hole, each bend inducing groove having a “V” shape, an apex of each “V”-shaped groove pointing towards the terminal hole.

11. The rechargeable battery of claim 2, the at least one bend inducing groove being arranged between the electrolyte injection hole and the terminal hole and having a “V” shape, an apex of the “V”-shaped groove pointing away from the terminal hole.

12. The rechargeable battery of claim 2, the at least one bend inducing groove comprising two bend inducing grooves, one on either side of the terminal hole, each bend inducing groove having a “V” shape, an apex of each “V”-shaped groove pointing away from the terminal hole.

13. The rechargeable battery of claim 4, a length of the bend inducing groove being greater than a diameter of the terminal hole.

14. The rechargeable battery of claim 1, further comprising an insulating gasket arranged within the terminal hole of the cap plate to insulate the electrode terminal from the cap plate.

15. The rechargeable battery of claim 1, further comprising:
a terminal plate electrically connected to the electrode terminal and being arranged between the electrode assembly and the cap plate;
an insulating plate arranged between the cap plate and the terminal plate to insulate the terminal plate from the cap plate; and
an insulating case arranged between the terminal plate and the electrode assembly to electrically insulate the terminal plate from the electrode assembly.

16. The rechargeable battery of claim 1, wherein a thickness of portions of the joint portions of the case arranged within the center portion is smaller than a thickness of portions of the joint portions of the case arranged within the side portions.

17. The rechargeable battery of claim 16, wherein a thickness of the front and back sidewalls of the case within the center portion is equal to a thickness of the front and back sidewalls of the case within the side portions.

18. A rechargeable battery, comprising:
a case having a front sidewall opposite a back sidewall, a bottom wall opposite an opening and joint portions connecting the bottom wall to each of the front and back sidewalls, the front and back sidewalls and the corresponding joint portions of the case each having a center portion and side portions on either side of the center portion and extending from the opening to the bottom wall;
an electrode assembly arranged within the case;
a cap plate arranged within the opening of the case to seal within the electrode assembly, the cap plate including at least one bend inducing groove; and
an electrode terminal extending through the cap plate and being electrically connected to the electrode assembly, wherein a thickness of the front and back sidewalls of the case is less than a thickness of the bottom wall of the case, wherein a thickness of portions of the joint portions of the case arranged within the center portion is smaller than a thickness of portions of the joint portions of the case arranged within the side portions.

19. A rechargeable battery, comprising:
a case having a front sidewall opposite a back sidewall, a bottom wall opposite an opening and joint portions connecting the bottom wall to each of the front and back sidewalls, the front and back sidewalls and the corresponding joint portions of the case each having a center line extending from the opening to the bottom wall;
an electrode assembly arranged within the case;
a cap plate arranged within the opening of the case to seal within the electrode assembly, the cap plate including at least one bend inducing groove; and
an electrode terminal extending through the cap plate and being electrically connected to the electrode assembly, wherein a thickness of the front and back sidewalls of the case is less than a thickness of the bottom wall of the case, wherein a curvature of an inner curved surface of the joint portions is greatest at the center line and decreases gradually with distance away from the center line.

20. The rechargeable battery of claim 19, wherein a thickness of the joint portions of the case is smallest at a center line and increases gradually with distance away from the center line.
